(19) United States
(12) Patent Application Publication
(10) Pub. No.: US 2017/0088303 A1
(43) Pub. Date: Mar. 30, 2017

(54) DEVICE FOR SEALING A BAG WITH TAMPER EVIDENT LABELING

(71) Applicant: Ben Clements & Sons, Inc., South Hackensack, NJ (US)

(72) Inventor: William DeSanti, Morris Plains, NJ (US)

(21) Appl. No.: 15/262,392

(22) Filed: Sep. 12, 2016

Related U.S. Application Data
(60) Provisional application No. 62/233,199, filed on Sep. 25, 2015.

(51) Int. Cl. B65C 1/02; B65C 9/42; B65C 9/08; B41J 3/407; B65C 9/00

(52) U.S. Cl. CPC B65C 1/02; B41J 3/4075; B65C 9/0065; B65C 9/08; B65C 9/42

(57) ABSTRACT

A device for sealing a bag includes a substrate having a slit. A ribbon supply supplies a ribbon. A printer assembly prints on the ribbon. A ribbon guide, rotatably disposed on the substrate on a first side of the slit receives the ribbon and guides the ribbon therethrough. A pressing tip is formed on the ribbon guide. An adhesive tape supply supplies an adhesive tape. A star wheel, is rotatably disposed on the substrate along the slit on an opposed side from, and in facing relationship with, the ribbon guide. The star wheel receives the adhesive tape and a portion of a bag moving through the slit, and applies adhesive tape to the bag. The pressing tip presses the ribbon against the adhesive tape and the bag. A cutter disposed along the slit, downstream of the star wheel cuts the ribbon and adhesive tape.

### CROSS-REFERENCE TO RELATED APPLICATION

This application claims the benefit of priority under 35 U.S.C §119(e) to U.S. Provisional Application No. 62/233,199, filed Sep. 25, 2015, which is incorporated herein by reference in its entirety.

### BACKGROUND OF THE INVENTION

The following invention is directed to a device for sealing a bag and, more particularly, for sealing a bag with a tamper evident seal, with printed information on the seal such as sale by date, production or code number.

Bag sealers are known in the art; however they are complex devices, including one sealer utilizing hot metal type sealers to melt the plastic material of the bag together to provide closure. These devices have been satisfactory, however they suffer from the disadvantage, that the use of the hot metal would burn any tape at the seal with the information thereon. Furthermore, operators of the device require special training, must use special caution or make use of sophisticated computer control to operate the device in an efficient safe manner.

Printed tapes on packaging is also known in the art, however they require chemical based inks to print the label on the sealed bag. It is even known in the art to preprint painted liners and transfer the printed material to the bag sealer. However, such devices suffer from the disadvantage that they require well trained sophisticated staff, dangerous ink chemicals, or industrial alcohol near food products which are often the contents of these plastic bags.

Accordingly, a device for overcoming the shortcomings of the prior art is desired.

### SUMMARY OF THE INVENTION

The present invention applies a sealing band, the band including a printed label so that a unitary printed sealing band is applied to seal a bag. The device includes a slit. At one side of the slit is a star wheel having cut outs therein. A paper ribbon guide is disposed on an opposed side of the slit from the star wheel and cooperates with the star wheel to close the bag as a bag moves through the slit and is engaged by the star wheel cut out and the paper ribbon guide. An adhesive tape is disposed about the star wheel and is pressed against and engages the package as the package engages the cut out. The paper ribbon guide receives a printed portion of the paper ribbon forming a label and presses the printed portion, with information printed thereon, against the adhesive to be affixed to the adhesive tape. A cutter tip, disposed downstream of the paper guide, cuts the adhesive tape and the printed label to form a butterfly printed label.

In a preferred embodiment, the device includes a print head upstream along a paper ribbon feed path from the paper guide. The cutter is moved between a first position and a second position as the bag moves downstream along the slit. The cutter is operationally connected to an actuator. Movement from the first position to the second position causes the actuator to cause the print head to print predetermined information on the paper ribbon.

### BRIEF DESCRIPTION OF THE DRAWINGS

The present disclosure is better understood by reading the detailed description with reference to the accompanied drawing figures in which the reference numerals denote the similar structure and like numbers refer to like structures in which:

FIG. 1 is a top plan view of the device for creating a tamper evident seal about a plastic bag in accordance with the invention;

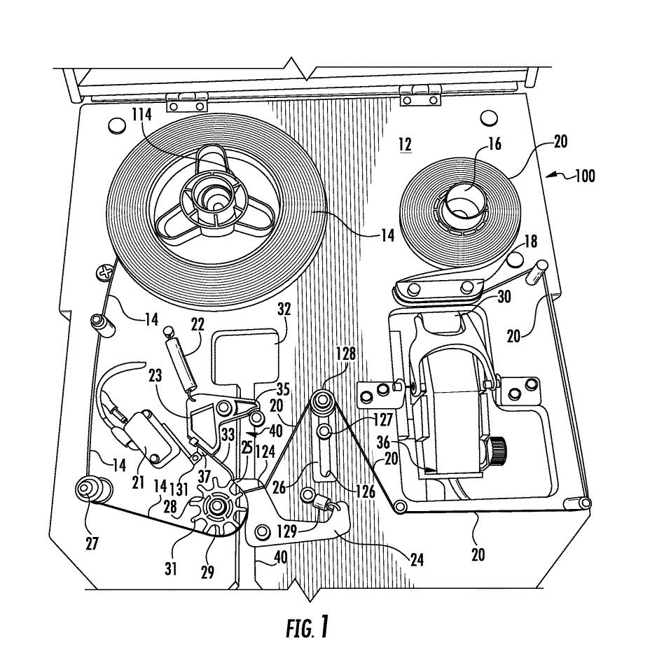

FIG. 2 is a perspective view of the print head assembly constructed in accordance with the invention; and

FIG. 3 is an end perspective view of the print head assembly constructed in accordance with an embodiment of the invention.

### DETAILED DESCRIPTION OF THE PREFERRED EMBODIMENT

Device 100 includes a substrate 12 formed of a sturdy non-warpable material such as a 3D manufactured plastic resin. A paper ribbon supplies spool 16 has a supply of paper ribbon 20 rotatably mounted about supply spool 16 so as to be selectively wound from supply spool 16 as will be discussed below.

Downstream for the purposes of this application shall mean the direction of travel along the path within device 100 of either the paper ribbon 20 or an adhesive tape 14. An anvil 18 is disposed downstream of supply spool 16. A printer assembly 36 is disposed across a gap in spaced relation from anvil 18, paper ribbon 20 passing through the gap between anvil 18 and printer assembly 36. Printer assembly 36 is at least in part moveable between a first position away from anvil 18 and a second position in which a print pad, or like structure, of printer assembly 36 applies a pressure to anvil 18.

Downstream of printer assembly 36 is an adjustable print roller 26. Adjustable print roller 26 is formed with a slit 126 therein. A positioning screw 127 is disposed within slit 126 and contacts adjustable print roller 26. A roller 128 is disposed at one end of adjustable print roller assembly 20 and is positioned along the feed path of paper ribbon 20 and engages and guides paper ribbon 20. Positioning screw 127 maintains adjustable roller assembly 20 in position. Positioning screw 127 may be disposed at any position along slit 126. In this way, the travel path of paper ribbon 20 may be adjusted by moving roller 128, into, or away from the feed path of paper ribbon 20.

A paper ribbon guide assembly 24 is rotatably mounted on substrate 12 downstream of adjustable roller assembly 26. Paper ribbon guide assembly 24 has a receiving slit 124 for receiving paper ribbon 20 therein. A slit 40 for receiving plastic bags therein is formed within substrate 12. Rotatable paper guide assembly 24 is disposed along slit 40. A pressing tip 25 is formed on paper ribbon guide 24. A spring 129 biases at least pressing tip 25 to extend across slit 40.

An adhesive tape supply spool 114 is rotatably disposed on substrate 12 and rotatably supports a supply of one sided pressure sensitive adhesive tape 14. At least one roller 27 is disposed downstream of adhesive tape supply spool 114 to guide pressure adhesive tape 14 through device 100. Adhesive tape 14 is disposed as to have only a single adhesive surface which faces away (outwardly) from roller 27 and the other guiding devices within device 100. It should be noted, that any two or more rollers, screws or other guiding mechanisms may be used along substrate 12, as known in the art to guide paper ribbon 20 or adhesive tape 14 through device 100.

A star wheel 28 is disposed downstream in the adhesive tape feed path from roller 27 and is disposed on substrate 12 in facing relationship with, and across slit 40 from, paper ribbon guide 24. Star wheel 28 is rotatably mounted on substrate 12. Star wheel 28 is formed with a plurality of cutouts 29 about the circumference thereof. Fingers 31 of cutouts 29 contact adhesive tape 14 and apply pressure against paper ribbon guide 24.

A cutter 23 having a cutting blade 33 extending therefrom is rotatably mounted on substrate 12 downstream of paper ribbon feeder 24 and star wheel 28. Cutter 23 includes a finger 35. Cutter 23 is biased by a spring 22 causing finger 35 to extend across slit 40. A contact 37 is disposed on cutter 23 adjacent cutting blade 33.

An actuator 21 is disposed on substrate 12 and operatively contacts contact 37 of cutter 33. Each time cutting blade 33 is rotated, as discussed below, contact 37 of cutter 23 moves away from actuator contact 131, the movement opening a switch at actuator 21 causing actuator 21 to send a signal to a PLC and reverse relay causing printer assembly 36 to print the predetermined information on paper ribbon 20.

A release opening 32 is provided in substrate 12 at an exit end of slit 40.

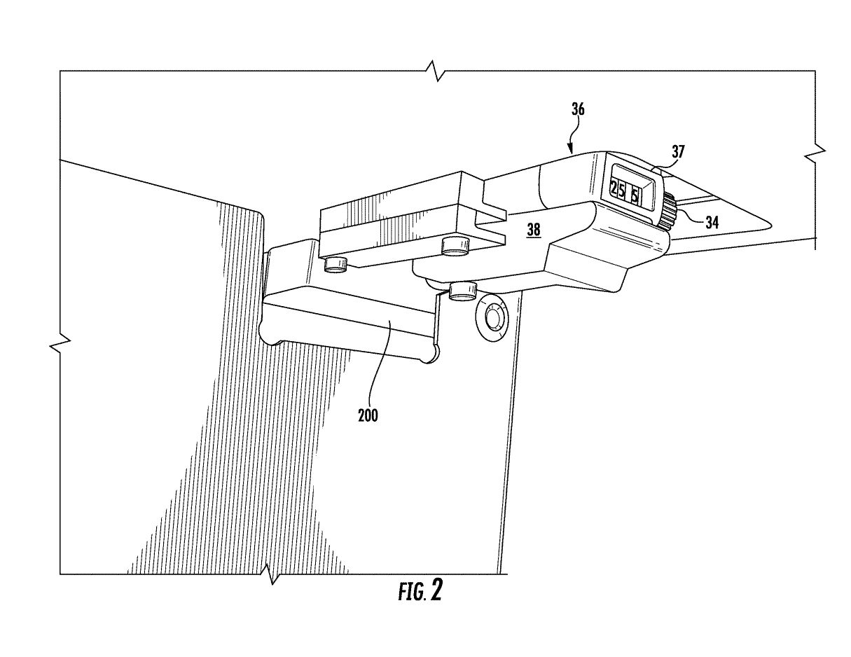

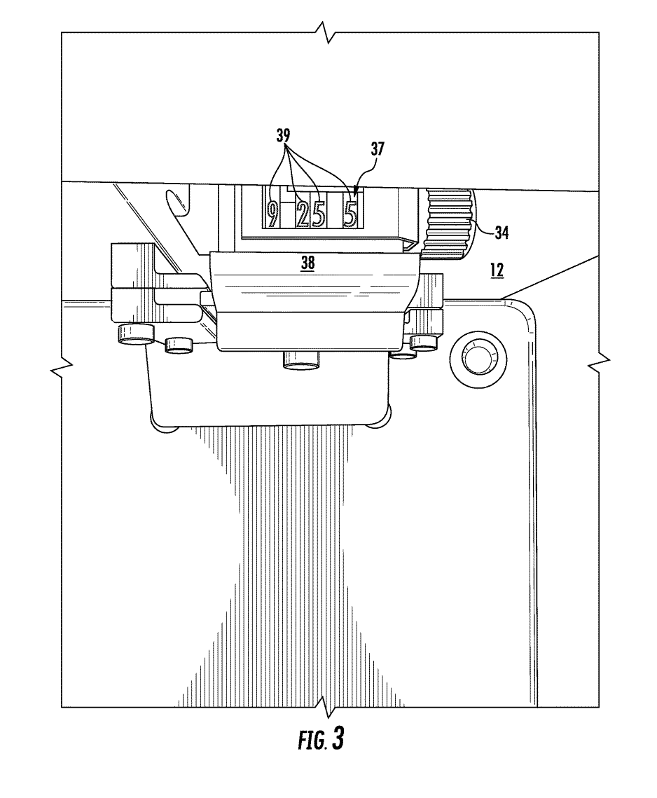

Reference is now also made to FIGS. 2 and 3 in which printer assembly 36 is shown in greater detail. Printer assembly 36 is disposed on a platform 38, supported by substrate 12. Ink roller 30 is located at a first end of printer assembly 36. Printer assembly 36 includes, in a non-limiting embodiment, a rotatable rubber stamp 37. Rotatable rubber stamp 37 is formed of a plurality of bands containing alpha numeric symbols 39 thereon. Rotation of the bands of rubberstamp 37 brings the desired alpha numeric symbols 39 into facing relationship with ink roller 30. A knob 34 coupled to each of the bands of rotatable rubber stamp 37 is rotated to place the desired alpha numeric symbol 39 in facing relationship with ink roller 30. A motor 200 drives at least a portion of printer assembly 36 to bring printer bands 37 in contact with ink roller 30 and then in contact with paper ribbon 20 as it is positioned against animal 18.

During operation, a plastic bag containing produce or any other item, is bunched or twisted at the top. The bag is inserted through slit 40 so that the twist is disposed within slit 40 and moved in a direction toward release opening 32. The twist of the bag engages a cut out 29 of star wheel 28 and pushes a portion of pressure sensitive adhesive tape into cut out 29 between fingers 31, about at least a portion of the twist, and rotates star wheel 31 as the bag passes. The twist is captured by fingers 31 and cutout 29, engages cutout 29 and fingers 31 to be released by star wheel 28 as the twist moves along slit 40. The orientation of the adhesive tape 14 is such that the non-adhesive side faces cut out 29 and the adhesive section faces the twist and adheres to the twist as pressure is applied by paper ribbon guide 24 between pressing tip 25 and fingers 31. Paper guide assembly 24, cooperating with star wheel 28 captures the twist as it passes thorough slit 40; closing off escape from cut out 29 by the twist.

The adhesive tape 14 forms a U beyond each side of the twist as function of extending along and beyond the cutout 29. As the twist moves along slit 40 towards paper pathway 124, the exposed adhesive tape 14 engages the printed paper ribbon 20 extending form slot 124. Paper ribbon 20 is pressed against tape 14 by pressing tip 25, is affixed to the adhesive tape 14, and encloses the twist to engage the other arm of the U, or butterfly, of the adhesive tape 14 sealing the twist. Passing pressing tip 25 within slit 40 presses paper ribbon 20 to the exposed adhesive tape 14 on either side of the twist.

Further movement along slit 40 causes the twist to engage finger 35 of cutter 23, rotating cutter 23 causing blade 33 to rotate into the pathway of slit 40 cutting the ribbon structure about the twist. Once the twist is within release opening 32 the expanded bag above the twist is easily passed through substrate 12.

Because adhesive 14 and ribbon 20 are in effect stuck to the bag from the position at which presser 25 presses the paper ribbon 20 against the adhesive tape 14, movement of the bag applies a force on both paper ribbon 20 and adhesive tape 14. Each of tape 14 and ribbon 20 are pulled to advance along the feed trail in a downstream direction. Therefore, a clean portion of ribbon 20 is positioned along anvil 18 in facing relationship with the printer assembly 36 once ribbon 20 has reached the cutting position. As the twist moves further along slit 40, finger 35 is deflected out of the pathway of slit 35 causing actuator 21 to switch state and send a signal to motor 200, utilizing PLC and reverse relay, in a preferred non-limiting embodiment, activating printer assembly 36 to print the information on ribbon 20. Cutter 23 is spring actuated by a spring 22 which restores it to the original position once the twist has moved through slit 40, returning actuator 21 to its non-actuating state.

Adjustable roller 20 is used to center the printed information relative to each cut length of paper ribbon 20. By moving roller 128 relative to the travel path of ribbon 20, the travel path may be lengthened or shortened. As a result, the relative position of the information as it approaches cutter 23 is adjusted.

By providing a simple mechanical device, which uses a slit to time printing, sealing, and cutting, and automatically orients the twist to the seal, a less sophisticated device is provided, but one that is capable of making a printed closure which must be destroyed to open; evidencing tampering

While this invention has been particularly shown and described to reference the preferred embodiments thereof, it would be understood by those skilled in the art that derivatives and changes in form and detail may be made therein without departing from the spirit and scope of the invention by the appended claims.

What is claimed is:

1. A device for sealing a bag comprising:
a substrate having a slit therein:
a paper ribbon supply for supplying a paper ribbon;
a printer assembly for selectively printing information on the paper ribbon;
a paper ribbon guide rotatably disposed on the substrate on a first side of the slit for receiving the paper ribbon and guiding the paper ribbon there through, a pressing tip formed on the paper guide assembly;
an adhesive tape supply for supplying an adhesive tape;
a star wheel, being rotatably disposed on the substrate along the slit on a side of the slit opposed from, and in facing relationship with, the paper ribbon guide; the star wheel having at least one cut out therein; the cut out receiving the adhesive tape and a portion of a bag moving through the slit, and applying the adhesive tape to the portion, the pressing tip pressing the paper ribbon against the adhesive tape applied at one or more positions adjacent to the portion of the bag; and
a cutter disposed along the slit downstream of the star wheel in a ribbon feed direction for cutting the paper ribbon and the adhesive tape.

2. The device for sealing a bag of claim 1, wherein the paper ribbon supply is adjustably mounted to the substrate relative to a ribbon travel path of a paper ribbon traversing the substrate.

3. The device for sealing a bag of claim 1, further comprising an actuary sending a signal to the printer assembly to print the information on the paper ribbon.

4. The device for sealing a bag of claim 1, wherein the cutter is operatively coupled to the actuator, and rotatably moves relative to the substrate to cut the paper ribbon and adhesive tape, the rotatable movement causing the actuator to send the signal to the printer assembly.

5. The device for sealing a bag of claim 1, wherein the paper ribbon guide is biased to extend across the slit, and movement of a bag traversing the slit rotates the paper ribbon guide so as not to extend across the slit.

6. The device for sealing a bag of claim 1, wherein the cutter has a cutting blade extending there from, and a finger extending across the slit, the cutter being rotatably mounted on the substrate such that movement of a bag within the slit contacting the finger rotates the cutter to bring the cutting blade into contact with the paper ribbon and adhesive tape.

7. The device for sealing a bag of claim 6, wherein the cutter is biased to extend the finger across the slit.

8. The device for sealing a bag of claim 1, further comprising a release opening communicating with the slit, for releasing a bag with in the slit from the substrate.

9. The device for sealing a bag of claim 1, further comprising an anvil, and the printer assembly including an increase roller, the ink roller being disposed in a spaced facing relationship with the anvil, a paper ribbon passing between the anvil and the ink roller as the paper ribbon travels from the ribbon supply to the paper ribbon guide.

10. The device for sealing a bag of claim 9, wherein the ink roller is movable between a first position away from the anvil, and a 2nd position contacting at least a paper ribbon disposed between the anvil and the ink roller for printing information on the paper ribbon.
